(19) United States
(12) Patent Application Publication
(10) Pub. No.: US 2012/0019631 A1
(43) Pub. Date: Jan. 26, 2012

(54) METHOD AND APPARATUS FOR REPRODUCING 3D CONTENT

(75) Inventors: Bo-mi KIM, Yongin-si (KR); Sang-il LEE, Suwon-si (KR); Hye-won LEE, Anyang-si (KR); Su-iin YEON, Seoul (KR); Hyun-cheol PARK, Suwon-si (KR); Moon-sik JEONG, Seongnam-si (KR)

(73) Assignee: Samsung Electronics Co., Ltd., Suwon-si (KR)

(21) Appl. No.: 13/187,990

(22) Filed: Jul. 21, 2011

(30) Foreign Application Priority Data
Jul. 21, 2010 (KR) 10-2010-0070369

(51) Int. Cl. H04N 13/04

(52) U.S. Cl. 348/51; 348/E13.075

(57) ABSTRACT

A method and apparatus for displaying an alternative object while reproducing three-dimensional (3D) content. The method includes reproducing the 3D content; during the reproducing of the 3D content, detecting an interrupt signal; determining a maximum depth value of the 3D content in response to detecting of the interrupt signal; adjusting a depth value of the 3D content according to the maximum depth value; and controlling a 3D content reproducing apparatus to display the alternative object corresponding to the interrupt signal, wherein the alternative object overlaps the 3D content of which the depth value is adjusted.

### PRIORITY

This application claims priority under 35 U.S.C. §119 to Korean Patent Application No. 10-2010-0070369, which was filed in the Korean Intellectual Property Office on Jul. 21, 2010, the entire disclosure of which is incorporated herein by reference.

### BACKGROUND OF THE INVENTION

1. Field of the Invention

The present invention relates generally to a method and apparatus for reproducing three-dimensional (3D) content, and more particularly, to a method and apparatus for displaying an alternative object such as a Graphic User Interface (GUI) object on a screen while 3D content is displayed on the screen.

2. Description of the Related Art

3D content includes general two-dimensional (2D) image information, and information about a depth between objects indicated in the 2D image. As 3D content reproducing apparatuses, such as 3D Televisions (TVs), are becoming more commercially available, there is a growing need for technologies for displaying messages and the like that are received through a 3D content reproducing apparatus or GUI for controlling the 3D content reproducing apparatus, without any collision with 3D content that is being reproduced during reproduction of the 3D content.

### SUMMARY OF THE INVENTION

Accordingly, the present invention has been made to solve the above-mentioned problems occurring in the prior art, and to provide at least the advantages as describe below.

According to an aspect of the present invention, a method of displaying an alternative object while reproducing 3D content is provided. The method includes reproducing the 3D content; during the reproducing of the 3D content, detecting an interrupt signal; determining a maximum depth value of the 3D content in response to detecting of the interrupt signal; adjusting a depth value of the 3D content according to the maximum depth value; and controlling a 3D content reproducing apparatus to display the alternative object corresponding to the interrupt signal, wherein the alternative object overlaps the 3D content of which the depth value is adjusted.

According to another aspect of the present invention, a method of displaying an alternative object while reproducing three-dimensional (3D) content is provided. The method includes reproducing the 3D content; while reproducing the 3D content, detecting an interrupt signal, obtaining a depth value of each 3D object included in the 3D content, in response to detecting the interrupt signal; determining a target 3D object having a depth value that is greater than or equal to a predetermined value; and displaying an alternative object corresponding to the interrupt signal in a different position from the target 3D object, wherein the alternative object overlaps the 3D content.

According to another aspect of the present invention, an apparatus for reproducing three-dimensional (3D) content is provided. The apparatus includes a depth value determining unit for obtaining depth values for each 3D object included in the 3D content; a reproducing unit for reproducing the 3D content; and a controller for, during the reproducing of the 3D content, detecting an interrupt signal, and for controlling the apparatus to display an alternative object corresponding to the interrupt signal, wherein the alternative object overlaps the 3D content.

### BRIEF DESCRIPTION OF THE DRAWINGS

The above and other aspects, features, and advantages of the present invention will become more apparent by describing in detail certain embodiments thereof with reference to the attached drawings, in which:

FIG. 1 illustrates 3D content and an alternative object being displayed on screens of a 3D content reproducing apparatus according to an embodiment of the present invention;

FIG. 2 illustrates a left image, a right image, a 2D image, which are included in 3D content, and depth map information about the 2D image, according to an embodiment of the present invention;

FIG. 3 is a block diagram illustrating a 3D content reproducing apparatus according to an embodiment of the present invention;

FIG. 4 is a flowchart illustrating a method of controlling reproduction of 3D content in a 3D content reproducing apparatus, according to an embodiment of the present invention;

FIG. 5 is a flowchart illustrating a method of controlling reproduction of 3D content in a 3D content reproducing apparatus, according to another embodiment of the present invention;

FIG. 6 illustrates 3D content and alternative objects in a 3D content reproducing apparatus according to an embodiment of the present invention;

FIG. 7 is a block diagram illustrating a 3D content reproducing apparatus, according to an embodiment of the present invention; and

FIG. 8 is a flowchart illustrating a method of controlling reproduction of 3D content in a 3D content reproducing apparatus, according to an embodiment of the present invention.

### DETAILED DESCRIPTION OF EMBODIMENTS OF THE INVENTION

Various embodiments of the present invention will now be described more fully with reference to the accompanying drawings. The present invention may, however, be embodied in many different forms and should not be construed as being limited to the embodiments set forth herein. Additionally, like reference numerals in the drawings denote like elements.

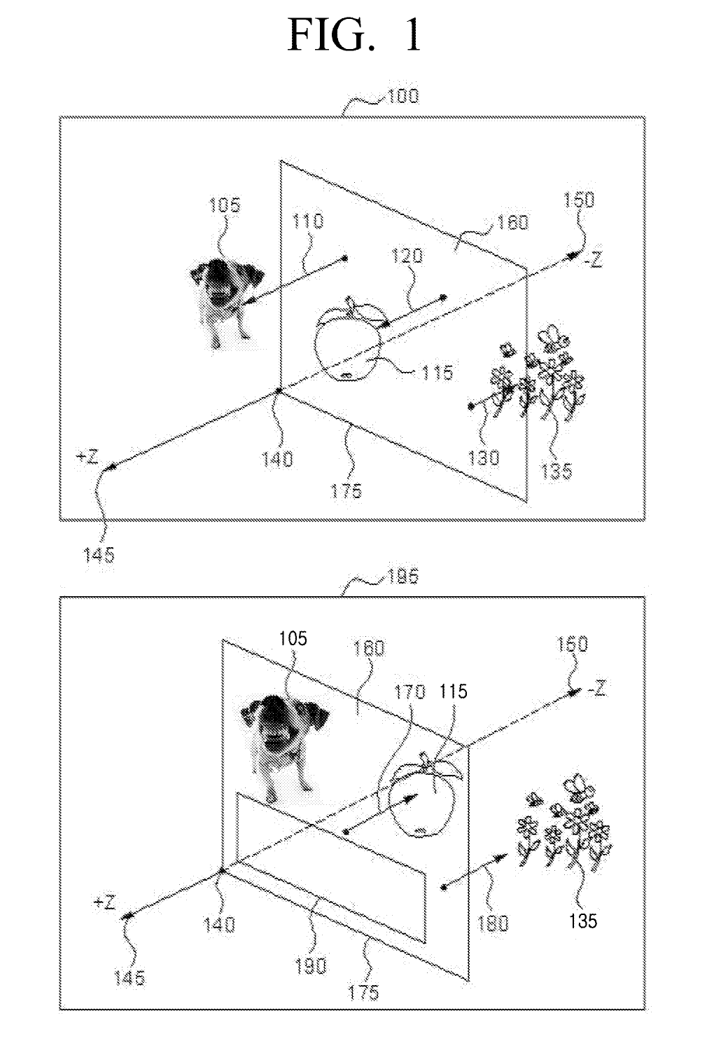

FIG. 1 illustrates 3D content and an alternative object being displayed on a screen of a 3D content reproducing apparatus according to an embodiment of the present invention.

Referring to FIG. 1, in frame 100, the 3D content is displayed on the screen 175. When the 3D content is reproduced, 3D objects 105, 115, and 135 are displayed on the screen 175. For example, the screen 175 may be a display device for displaying the 3D content. The display device may be a part of a mobile apparatus such as a 3D TV or a cellular phone.

The 3D objects 105, 115, and 135 are positioned in a +Z-axis direction 145 and a −Z-axis direction 150 in relation to a screen surface 160. Alternatively, the 3D objects 105, 115, and 135 may be positioned on the screen surface 160. For example, in frame 100, the 3D objects 105 and 115 are in positions that are moved from the screen surface 160 in the +Z-axis direction 145, and the 3D object 135 is in a position that is moved from the screen surface 160 in the −Z-axis direction 150. Further, in frame 195, the 3D objects 120 and 135 are in positions that are moved from the screen surface 160 in the -Z-axis direction 150, and the 3D object 105 is positioned on the screen surface 160.

In frame 100, the 3D objects 105, 115, and 135 have characteristic depth values 110, 120, and 130, respectively, and in frame 195, the 3D objects 115 and 135 have characteristic depth values 170 and 180, while the 3D object 105 has no characteristic depth value as it is positioned on the screen surface 160. The characteristic depth values 110, 120, 130, 170, and 180 indicate distances from the screen surface 160 to the 3D objects 105, 115, 135, 155, 165, and 185, respectively.

In FIG. 1, the screen surface 160 is a reference surface for measuring a depth value. Additionally, in FIG. 1, the depth value of the screen surface 160 is set to 0; however, because the depth value of the screen surface is a relative value, it could also be set to another value.

When a 3D object is positioned in front of the screen surface 160, that is, in a position that is moved from the screen surface 160 in the +Z-axis direction 145, a depth value of the 3D object has a positive “+” value. If a 3D object is positioned behind the screen surface 160, that is, in a position that is moved from the screen surface 160 in the −Z-axis direction 150, a depth value of the 3D object has a negative “−” value. For example, the depth value of the 3D object 105 may be +50. The depth value of the 3D object 115 may be +30. The depth value of the 3D object 135 may be −15.

When the 3D objects 105 and 115 are in positions that are moved from the screen surface 160 in the +Z-axis direction 145, as in frame 100, a user recognizes that the 3D objects 105 and 115 are positioned in front of the screen surface 160. When the 3D objects 115 and 135 are positioned in positions that are moved from the screen surface 160 in the -Z-axis direction 150, as in frame 195, the user recognizes that the 3D objects 115 and 135 are positioned behind the screen surface 160.

Additionally, in frame 195, an alternative object 190 is positioned on the screen surface 160.

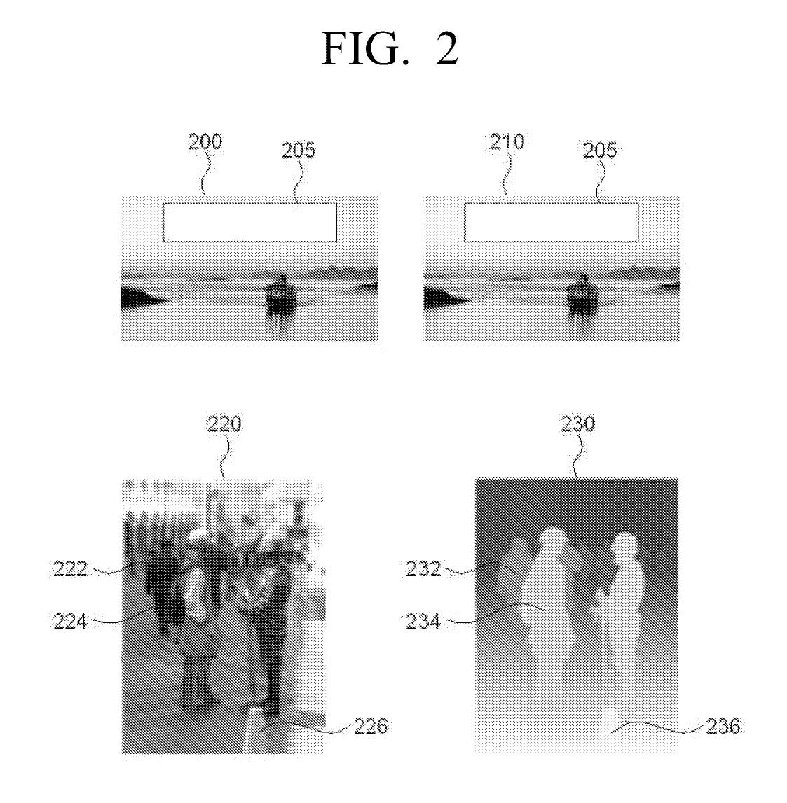

FIG. 2 illustrates a left image, a right image, a 2D, which are included in 3D content, and depth map information about the 2D image, according to an embodiment of the present invention.

More specifically, FIG. 2 illustrates stereoscopic content, as an example of 3D content, including a left image 200 and a right image 210. An alternative object 205 overlaps the left image 200 and the right image 210. Another example of 3D content includes the 2D image 220 and the depth map information 230 about the 2D image 220. Objects 222, 224, and 226 included in the 2D image 220 are displayed with different brightness in the depth map information 230 as objects 232, 234, and 236, respectively. The object 222 that is positioned farthest in the 2D image 220 corresponds to an object 232 that is displayed relatively dark in the depth map information 230. The object 226 that is positioned closest in the 2D image 220 corresponds to an object 236 that is displayed relatively bright in the depth map information 230. The object 224 that is positioned in the middle in the 2D image 220 corresponds to an object 234 that is displayed to have medium brightness in the depth map information 230.

The depth map information refers to an image having respective depth values of 3D objects included in the 3D content. The depth map information has brightness that varies according to the depth value of the 3D object. The greater the depth value of the 3D object, the brighter the 3D object. The smaller the depth value of the 3D object, the darker the 3D object. Thus, the depth map information may look like a black and white image having a level from 0 to 255 according to the depth value of the 3D object. When the depth value is the greatest, the level is 255, and the 3D object is brightest. When the depth value is the smallest, the level is 0, and the 3D object is darkest. The screen surface has a level of 128 that is a medium depth value, and the screen surface has medium brightness.

Obtaining the depth value of a 3D object included in the 3D content may include obtaining the depth value from the depth value information, and adjusting the depth map information so that the maximum depth value is identical to a depth value of the screen surface. As the depth value is adjusted, brightness of an image indicating the depth map information may vary. For example, as the depth value of the 3D object is adjusted from +50 to 0, entire brightness of the image indicting the depth map information may be darker.

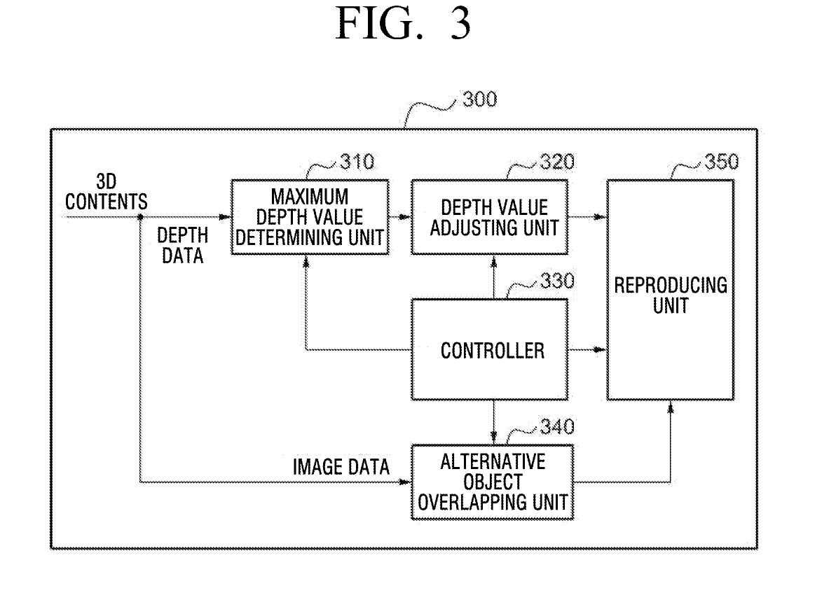

FIG. 3 is a block diagram illustrating a 3D content reproducing apparatus according to an embodiment of the present invention.

Referring to FIG. 3, a 3D contents reproducing apparatus 300 includes a maximum depth value determining unit 310 for obtaining depth values from 3D content and determining a maximum depth value from among the depth values, a depth value adjusting unit 320 for adjusting the depth values, a reproducing unit 350 for reproducing the 3D content, and a controller 330 for detecting an interrupt signal, during the reproduction of the 3D content, for controlling the depth value adjusting unit 320 to adjust the depth values according to the maximum depth value, in response to the detection of the interrupt signal, and for controlling an alternative object overlapping unit 340 to display an alternative object corresponding to the interrupt signal, such that the alternative object overlaps the 3D content of which the depth values are adjusted.

Although, the maximum depth value determining unit 310, the depth value adjusting unit 320, the reproducing unit 350, and the alternative object overlapping unit 340 are illustrated as separate hardware blocks in FIG. 3, alternatively, these units may be configured as a single unit or may be included within the controller 330.

The 3D content may be transmitted from a broadcasting station, or may be transmitted from a storage medium. The 3D content includes 3D objects having respective depth values. The maximum depth value determining unit 310 determines the maximum depth value from among the depth values. The maximum depth value is a depth value of a 3D object that is positioned foremost from a screen surface in a +Z-axis direction from a screen surface. The maximum depth value is a greatest value from among depth values obtained in the +Z-axis direction. For example, referring to FIG. 1, the 3D object 105 in frame 100 is positioned farthest from the screen surface 160 in the +Z-axis direction. Thus, the characteristic depth value 110 of the 3D object 105 is the maximum depth value.

In order to determine the maximum depth value, the maximum depth value determining unit 310 compares the characteristic depth values 110, 120, and 130 of the 3D objects 105, 115, and 135, and determines the characteristic depth value 110, which is the greatest value from among the characteristic depth values 110, 120, and 130, as the maximum depth value.

The depth value adjusting unit 320 adjusts the depth values of the 3D objects. Again, referring to FIG. 1, the depth values of the 3D objects 105,115, and 135 are adjusted in frame 195. The depth value adjusting unit 320 adjusts the characteristic depth value 110 of the 3D object 105 so as to position the 3D object 105 having the maximum depth value on the screen surface 160. For example, it is assumed that the characteristic depth value 110 of the 3D object 105 is +50, the characteristic depth value 120 of the 3D object 115 is +30, and the characteristic depth value 130 of the 3D object 135 is −15. In this case, the maximum depth value is +50. The depth value adjusting unit 320 adjusts the characteristic depth value 110 of the 3D object 105 from +50 to 0 so as to position the 3D object 105 on the screen surface 160. The 3D object 105 of FIG. 1 corresponds to a case where the characteristic depth value 110 of the 3D object 105 is not adjusted. The depth value of the 3D object 105 is adjusted according to the maximum depth value, and then the 3D object 105 is displayed on the screen surface 160 in frame 195. The depth value adjusting unit 320 may reduce the depth value of the 3D contents according to the maximum depth value. When the maximum depth value is +50, the depth value adjusting unit 320 may reduce the depth value of the 3D contents from the respective characteristic depth value by 50.

The depth value adjusting unit 320 may gradually adjust the depth value of the 3D content. As the depth value is gradually adjusted, the user may feel as if the 3D content is slowly moved backward. For example, when the depth value adjusting unit 320 reduces a depth value of a 3D object included in the 3D content, the depth value adjusting unit 320 initially adjusts the depth value to 40. Then, the depth value is adjusted to 30. Then, the depth value is adjusted to 20. This operation is repeated until the depth value is 0. As the depth value adjusting unit 320 may gradually adjust the depth value of the 3D object, it looks as if the 3D object is gradually moved inward.

The depth value adjusting unit 320 may adjust a depth value so as to move at least one 3D object included in the 3D contents in a −Z-axis direction as much as the maximum depth value. Referring to FIG. 1, original depth values 110, 120, and 130 of the 3D objects 105, 115, and 135 are adjusted according to the maximum depth value. When the maximum depth value is the characteristic depth value 110, i.e., +50, the characteristic depth values 110, 120, and 130 of the 3D objects 105, 115, and 135 are reduced by +50. Thus, the characteristic depth value 110 of the 3D object 105 is changed to 0 by reducing the characteristic depth value 110 from +50 by 50. The characteristic depth value 120 of the 3D object 115 is changed to −20 by reducing the characteristic depth value 120 from +30 by 50. The depth value 130 of the 3D object 135 is changed to −65 by reducing the characteristic depth value 125 from −15 by 50.

Adjusting a depth value according to the maximum depth value refers to adjusting the depth value by using the maximum depth value as a reference value. The reference value may be the same as the maximum depth value, or alternatively, may be greater or smaller than the maximum depth value by a predetermined margin.

The reproducing unit 350 decodes the 3D content, and displays 3D objects included in the 3D content on a screen surface, or in positions that are moved from the screen surface in a +Z-axis direction and a −Z-axis direction. The reproducing unit 350 displays the 3D content on a screen with reference to depth values provided from the depth value adjusting unit 320.

The controller 330 controls the maximum depth value determining unit 310, the depth value adjusting unit 320, the reproducing unit 350, and the alternative object overlapping unit 340. The controller 330 detects an interrupt signal while the reproducing unit 350 reproduces the 3D content. The interrupt signal may be detected while the 3D objects included in the 3D content are reproduced. When the controller 330 detects the interrupt signal, the controller 330 controls the 3D content reproducing apparatus 300 to stop a task that is currently performed and to perform another task, or to perform another task together with the task that is currently performed. The interrupt signal may be generated by a signal received by a remote controller, a signal indicating that a message is received, or a video telephone image signal received through a video telephone.

For example, when a user pushes a menu button of a remote controller in order to display a GUI during reproduction of the 3D content, an interrupt signal is generated.

When the controller 330 detects the interrupt signal, the controller 330 controls the depth value adjusting unit 320 to adjust a depth value according to the maximum depth value and to display an alternative object on the 3D content of which the depth value is adjusted, according to the maximum depth value. For example, when the 3D object included in the 3D content is displayed on the screen, and the controller 330 detects the interrupt signal, the depth value adjusting unit 320 adjusts the depth value, displays the 3D object included in the 3D content, and display the alternative object to overlap the 3D content.

For example, the alternative object may include a GUI object, a message, a video telephone image, a subtitle, caption data, etc. The GUI object may include a figure, a character, an image, etc., which is displayed on the screen. The message may be a message or an email that is received through a communications network. The video telephone image may be received through a communications network. The subtitle and the caption data may be subtitles provided together with the 3D content. In addition, the alternative object may include content received through the Internet. The alternative object may include an object that is generated in the 3D content reproducing apparatus 300 or is received from an external source, and is capable of being displayed on the screen.

The alternative object may overlap the 3D content in a position corresponding to a predetermined depth value that is obtained by gradually changing an original depth value. The predetermined depth value may be the same as a depth value of the screen surface. For example, initially, the alternative object may be displayed in a position corresponding to a depth value of +50 on the screen. Then, the alternative object may be displayed in a position corresponding to a depth value of +40 on the screen, and then, may be displayed in a position corresponding to a depth value of +30 on the screen. That is, as a depth value is gradually reduced, the alternative object may be displayed on the screen. This operation is repeated until the depth value reaches a predetermined value. The controller 330 may control the 3D content reproducing apparatus 300 to display the alternative object on the screen. When the predetermined value is the same as a depth value of the screen surface, the alternative object may be positioned on the screen surface.

Referring to FIG. 2, when 3D content includes the left image 200 and the right image 210, the maximum depth value determining unit 310 obtains the depth value by comparing an outline of the left image 200 and an outline of the right image 210. The maximum depth value determining unit 310 extracts the outlines from the left image 200 and the right image 210, compares the outlines, and obtains the depth value. The maximum depth value determining unit 310 obtains a shifting degree of the 3D object included in the 3D content by comparing the outlines of the left image 200 and the right image 210, and obtains a depth value according to the shifting degree.

The alternative object overlapping unit 340 overlaps the alternative object 205 with the left image 200 and the right image 210 in order to overlap the alternative object 205 with the 3D content including the left image 200 and the right image 210. The alternative object overlapping unit 340 may shift at least one of the left image 200 and the right image 210 so that the alternative object 205 may be positioned on the screen surface.

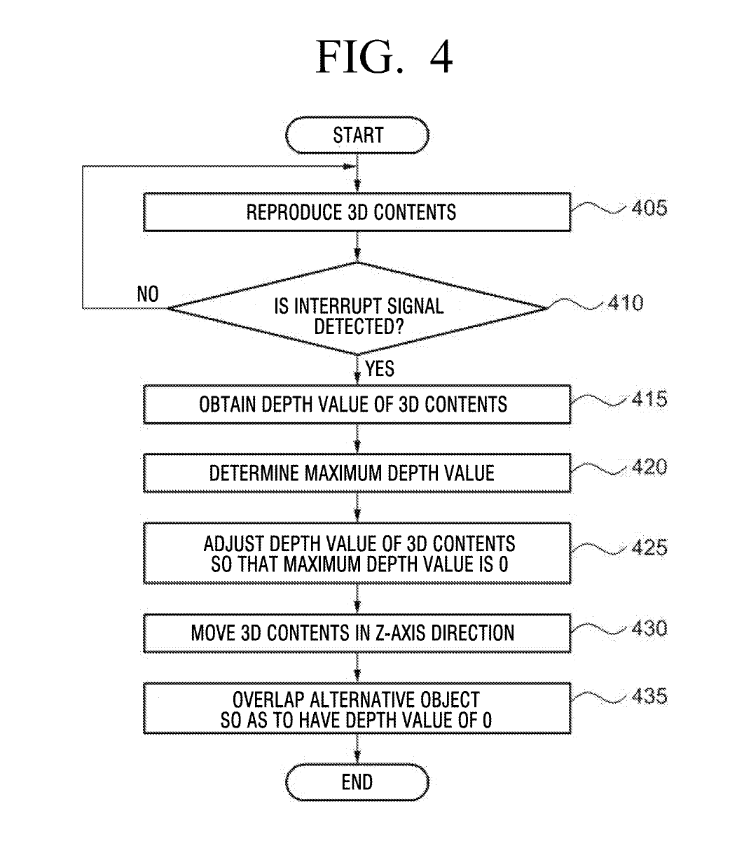

FIG. 4 is a flowchart illustrating a method of controlling reproduction of 3D content in a 3D content reproducing apparatus, according to an embodiment of the present invention.

Referring to FIG. 4, the 3D content reproducing apparatus reproduces 3D content including 3D objects in step 405. The 3D objects have respective depth values. When the 3D contents are reproduced, the 3D objects may be displayed on a screen. Image portions corresponding to the 3D objects may be displayed to protrude forward from a screen surface, may be displayed concave inward from the screen surface, or may be displayed on the screen surface, according to the depth value of the 3D objects. For example, in FIG. 1, the image portions corresponding to the 3D objects 105 and 115 protrude forward from the screen surface 160. In addition, an image portion corresponding to the 3D object 135 may be displayed concave inward from the screen surface 160.

A controller detects an interrupt signal during the reproduction of the 3D content in step 410. The controller then obtains depth values of the 3D content in step 415, to determine a maximum depth value of the 3D content in step 420, in response to the detection of the interrupt signal detected by the controller.

When the 3D content is a stereoscopic image, the controller obtains a depth value by comparing a left image and a right image. When the 3D content includes a 2D image and depth map information, the controller obtains a depth value from depth map information.

As described above, the maximum depth value is a depth value of a 3D object that is positioned farthest from a screen in the +Z-axis direction 145, as illustrated in FIG. 1.

In step 425, the controller adjusts the depth value of the 3D content so that the maximum depth value of the 3D content, for example, is 0. When the depth value is adjusted according to the maximum depth value, the depth value is adjusted so that the maximum depth value of the 3D content is 0.

In step 430, the controller moves the 3D content in the −Z-axis direction 150 by adjusting the characteristic depth values of the 3D objects therein, as described above in relation to FIG. 1.

Thereafter, an alternative object corresponding to the interrupt signal is overlapped onto the adjust 3D content on the screen surface.

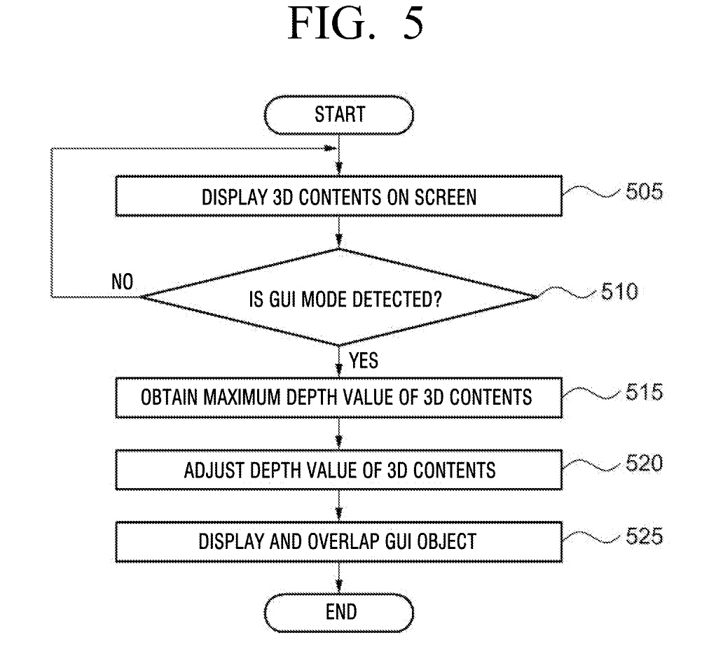

FIG. 5 is a flowchart illustrating a method of controlling reproduction of 3D content in a 3D content reproducing apparatus, according to an embodiment of the present invention.

Referring to FIG. 5, a controller controls the 3D content reproducing apparatus to display 3D content including 3D objects in step 505.

While the 3D content is displayed on a screen, the controller determines if a GUI mode is detected in step 510. The GUI mode is a mode in which a GUI object is displayed on the screen. The GUI object may include a figure, or a text. In the GUI mode, the GUI object may overlap the 3D content.

When the GUI mode is detected, the controller obtains a maximum depth value of the 3D content in step 515. As described above, in order to obtain the maximum depth value, the controller obtains respective depth values of the 3D objects included in the 3D content, compares the depth values of the 3D objects, and determines the greatest value as the maximum depth value.

In step 520, the controller adjusts a depth value of the 3D content according to the maximum depth value.

In step 525, the controller displays the GUI object overlapping the 3D content of which the depth value is adjusted.

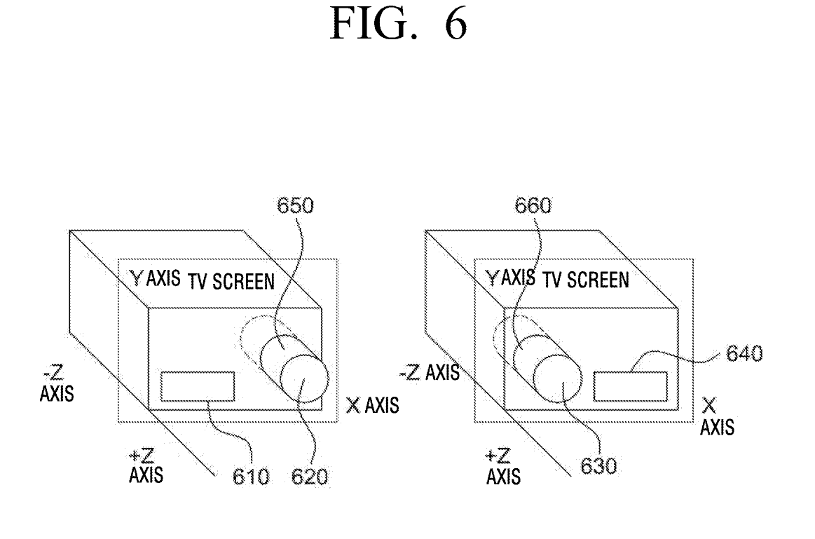

FIG. 6 is a diagram illustrating 3D content and alternative objects in a 3D content reproducing apparatus according to an embodiment of the present invention.

Referring to FIG. 6, two TV screens are illustrated where 3D objects 620 and 630, with depth values 650 and 660, respectively, and the alternative objects 610 and 640 are displayed. Basically, the alternative objects 610 and 640 are positioned in different positions from positions of the 3D objects 620 and 630.

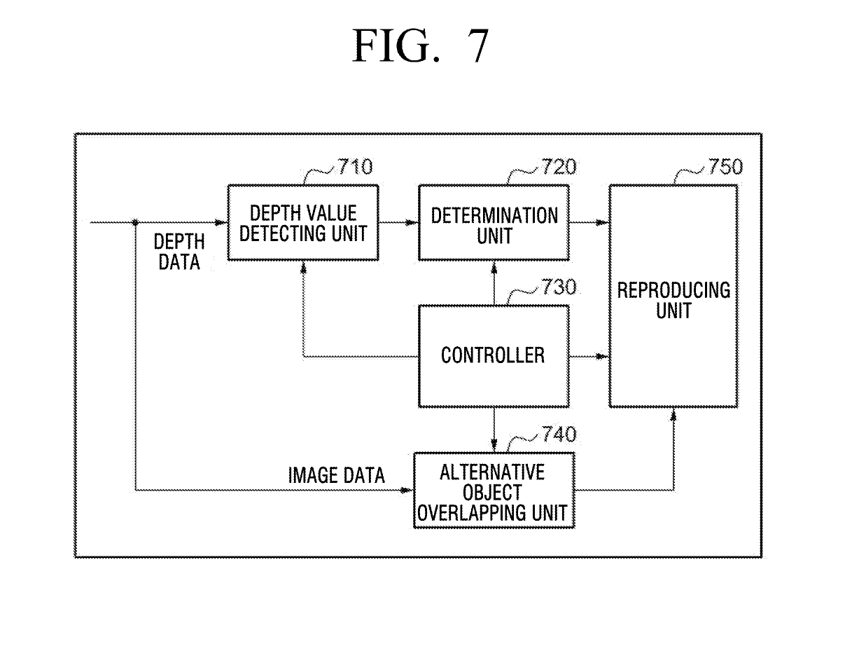

FIG. 7 is a block diagram of a 3D content reproducing apparatus, according to an embodiment of the present invention.

Referring to FIG. 7, the 3D content reproducing apparatus includes a depth value detecting unit 710 for obtaining a depth value of at least one 3D object included in the 3D content, a determination unit 720 for determining at least one target 3D object having a depth value that is equal to or more than a predetermined value from among the 3D objects, and a controller 730 for detecting an interrupt signal, during reproduction of the 3D content, for controlling the 3D content reproducing apparatus to display an alternative object corresponding to the interrupt signal in a different position from a position of the target 3D object in response to the detection of the interrupt signal. The 3D content reproducing apparatus further includes a reproducing unit 750 for decoding the 3D content and displaying the 3D content on a screen. The 3D content reproducing apparatus further includes an alternative object overlapping unit 740 for displaying the alternative object to overlap the 3D content.

When the 3D content is input to the depth value detecting unit 710, the depth value detecting unit 710 detects a respective depth value for each 3D object included in the 3D content. If the 3D content includes a 2D image and depth map information, a depth value may be obtained from the depth map information.

When the 3D content includes a left image and a right image, a depth value of the 3D content is obtained by comparing an outline of the left image and an outline of the right image.

The determination unit 720 determines a target 3D object having a depth value that is equal to or more than a predetermined value from among depth values detected by the depth value detecting unit 710. The predetermined value may be the maximum depth value. For example, if the predetermined value is +20, a 3D object having a depth value that is equal to or more than 20 in a +Z-axis direction may be the target 3D object. If the predetermined value is +10, a 3D object having a depth value that is equal to or more than 10 in the +Z-axis direction may be the target 3D object.

The determination unit 720 also detects a position of the target 3D object. For example, in FIG. 6, in the first screen, the 3D object 620 with the depth value 650 would be selected as the target 3D object, and is positioned in a bottom right position on the screen. In addition, in the second screen, the 3D object 630 with the depth value 650 would be selected as the target 3D object, and is positioned in a bottom left position on the screen. A position of the target 3D object on the screen may be expressed in terms of a XY plan including the X axis and the Y axis.

The controller 730 determines a position of an alternative object by using a position of the target 3D object. Further, the controller 730 controls the depth value detecting unit 710, the determination unit 720, the reproducing unit 750, and the alternative object overlapping unit 740. Accordingly, the controller 730 receives the position of the target 3D object on the screen from the determination unit 720, and controls the alternative object overlapping unit 740 and the reproducing unit 750 to overlap the alternative object onto the 3D content in a different position on the screen from the position of the target 3D object

Although, the depth value detecting unit 710, the determination unit 720, the reproducing unit 750, and the alternative object overlapping unit 740 are illustrated as separate hardware blocks in FIG. 7, alternatively, these units may be configured as a single unit or may be included within the controller 730.

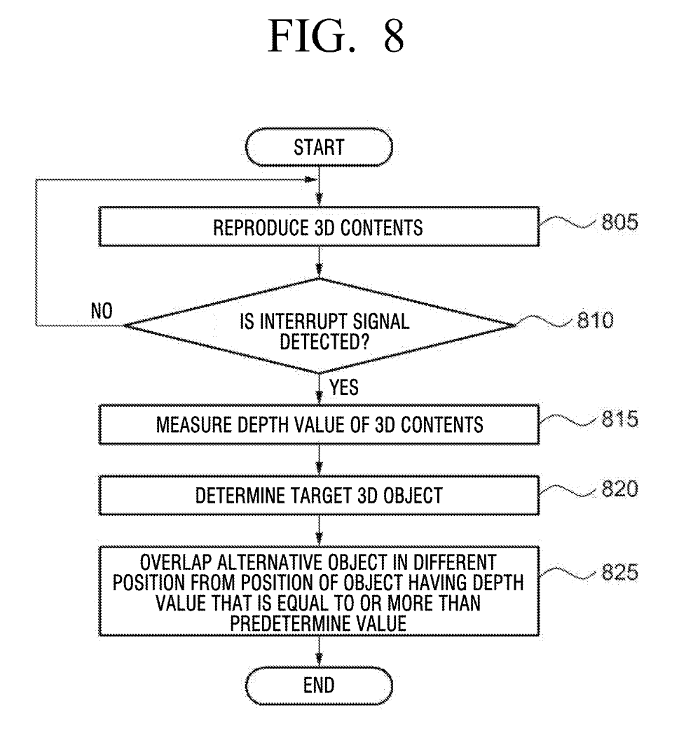

FIG. 8 is a flowchart illustrating a method of controlling reproduction of 3D content in a 3D content reproducing apparatus, according to an embodiment of the present invention.

Referring to FIG. 8, the method includes reproducing 3D content in step 805, detecting an interrupt signal during the reproduction of the 3D content in step 810, obtaining a depth value of at least one 3D object included in the 3D content, in response to the detection of the interrupt signal, in step 815, determining at least one target 3D object having a depth value that is equal to or more than a predetermined value from among the 3D objects in step 820, and displaying an alternative object to overlap the 3D content in a different position from the target 3D object.

The displaying the alternative object may further include determining a position of the alternative object by using a position of the target 3D object. In this case, the position of the target 3D object is expressed in terms of a XY plan, but not a Z-axis direction. Because the position of the alternative object is determined according to the position of the target 3D object, the position of the alternative object may vary. For example, as illustrated in FIG. 6, the alternative objects 610 and 640 are positioned in different positions, depending the positions of 3D objects 620 and 630.

In addition, the above and other embodiments of the present invention can also be implemented through computer readable code/instructions in/on a medium, e.g., a computer readable medium, to control at least one processing element to implement any above described embodiment. The medium can correspond to any medium/media permitting the storage and/or transmission of the computer readable code. The computer readable code can be recorded/transferred on a medium in a variety of ways, with examples of the medium including recording media, such as magnetic storage media (e.g., Read Only Memory (ROM), floppy disks, hard disks, etc.) and optical recording media (e.g., Compact Disc (CD)-ROMs, or DVDs), and transmission media such as Internet transmission media. Thus, the medium may be such a defined and measurable structure including or carrying a signal or information, such as a device carrying a bit stream according to one or more embodiments of the present invention. The media may also be a distributed network, so that the computer readable code is stored/transferred and executed in a distributed fashion. Furthermore, the processing element could include a processor or a computer processor, and processing elements may be distributed and/or included in a single device.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. A method of displaying an alternative object while reproducing three-dimensional (3D) content, the method comprising:
reproducing the 3D content;
while reproducing the 3D content, detecting an interrupt signal;
determining a maximum depth value of the 3D content, in response to detecting the interrupt signal;
adjusting a depth value of the 3D content according to the maximum depth value; and
controlling a 3D content reproducing apparatus to display an alternative object corresponding to the interrupt signal,
wherein the alternative object overlaps the 3D content of which the depth value is adjusted.

2. The method of claim 1, wherein determining the maximum depth value of the 3D content comprises:
obtaining a depth value of each 3D object included in the 3D content; and
determining the maximum depth value from among the depth values of each 3D object.

3. The method of claim 2, wherein adjusting the depth value of the 3D content comprises adjusting a depth value of a 3D object having the determined maximum depth value to adjust the 3D object to be positioned on a screen surface.

4. The method of claim 2, wherein the 3D content includes a left image and a right image, and
wherein obtaining the depth value of the 3D object comprises comparing an outline of the left image and an outline of the right image.

5. The method of claim 4, further comprising:
overlapping the alternative object on the left image and the right image; and
shifting at least one of the right image and the left image so that the alternative object is positioned on a screen surface.

6. The method of claim 2, wherein the 3D content includes a two-dimensional (2D) image and depth map information corresponding to the 2D image, and
wherein obtaining the depth value of the 3D object comprises obtaining the depth value from the depth map information, and adjusting the depth map information so that the maximum depth value is identical to a depth value of a screen surface.

7. The method of claim 6, wherein the alternative object overlaps the 3D content on the screen surface.

8. The method of claim 1, wherein the adjusting of the depth value comprises adjusting the depth value of at least one 3D object included in the 3D content in a −Z-axis direction by a value equal to the maximum depth value.

9. The method of claim 1, wherein the alternative object includes at least one of a Graphic User Interface (GUI) object, a message, a video telephone image, a subtitle, and caption data.

10. The method of claim 1, wherein adjusting the depth value comprises adjusting a depth value of a 3D object included in the 3D content according to the maximum depth value.

11. A method of displaying an alternative object while reproducing three-dimensional (3D) content, the method comprising:
reproducing the 3D content;
while reproducing the 3D content, detecting an interrupt signal;
obtaining a depth value of each 3D object included in the 3D content, in response to detecting the interrupt signal;
determining a target 3D object having a depth value that is greater than or equal to a predetermined value; and
displaying an alternative object corresponding to the interrupt signal in a different position from the target 3D object, wherein the alternative object overlaps the 3D content.

12. The method of claim 15, wherein displaying the alternative object comprises:
determining a position of the target 3D object; and
determining a position of the alternative object based on the position of the target 3D object.

13. An apparatus for displaying an alternative object while reproducing three-dimensional (3D) content, the apparatus comprising:
a depth value determining unit for obtaining depth values for each 3D object included in the 3D content;
a reproducing unit for reproducing the 3D content; and
a controller for, during the reproducing of the 3D content, detecting an interrupt signal, and for controlling the apparatus to display an alternative object corresponding to the interrupt signal, wherein the alternative object overlaps the 3D content.

14. The apparatus of claim 13, wherein depth value determining unit determines a maximum depth value from among the depth values of each 3D object included in the 3D content,
wherein apparatus further comprises a depth value adjusting unit for adjusting the depth values of each 3D object included in the 3D content, and
wherein the controller controls the depth value adjusting unit to adjust the depth values according to the maximum depth value, in response to the detecting of the interrupt signal, such that the alternative object overlaps the 3D content of which the depth values are adjusted.

15. The apparatus of claim 13, wherein the depth value adjusting unit adjusts the depth value of a 3D object having the determined maximum depth value so that the 3D object having the determined maximum depth value is positioned on a screen surface.

16. The apparatus of claim 13, wherein the depth value adjusting unit reduces the depth value of at least one 3D object included in the 3D content according to the maximum depth value.

17. The apparatus of claim 13, wherein the alternative object comprises at least one of:
a Graphic User Interface (GUI) object;
a message;
a video telephone image;
a subtitle; and
caption data.

18. The apparatus of claim 13, wherein the 3D content comprises a left image and a right image, and
wherein the depth value determining unit obtains the depth value by comparing an outline of a 3D object in the left image and an outline of a 3D object the right image.

19. The apparatus of claim 13, further comprising:
a determination unit for determining at least one target 3D object having a depth value that is greater than or equal to a predetermined value,
wherein the controller controls the apparatus to display the alternative object corresponding to the interrupt signal in a different position from a position of the target 3D object, in response to detecting the interrupt signal.

20. The apparatus of claim 19, wherein the controller determines a position of the alternative object based on a position of the target 3D object.
